(19) United States
(12) Patent Application Publication
(10) Pub. No.: US 2017/0367516 A1
(43) Pub. Date: Dec. 28, 2017

(54) Rapid Food Cooking Device and Rapid Cooking Method Therefor

(71) Applicant: Dongguan Xiqin Electrical Appliance Co., Ltd., Dongguan, Guangdong Province (CN)

(72) Inventor: Dashuai HU, Dongguan (CN)

(21) Appl. No.: 15/540,146

(22) PCT Filed: Dec. 24, 2015
(86) PCT No.: PCT/CN2015/098804

§ 371 Date: Jun. 27, 2017

(30) Foreign Application Priority Data
Dec. 31, 2014 (CN) 201410845034.0

(51) Int. Cl. A47J 27/04; A23L 5/10

(52) U.S. Cl. CPC A47J 27/04; A23L 5/13; A47J 2027/043; A23V 2002/00

(57) ABSTRACT

The invention relates to a rapid food cooking device and a rapid cooking method thereof. The rapid food cooking device comprises an independent water tank(100), a check unit(200), a rapid evaporation unit(300) and a cooking unit(400). The independent water tank (100)is used for containing water for generating steam, the water, for generating the steam, in the independent water tank (100)is constantly and quantitatively supplied to the rapid evaporation unit(300), the rapid evaporation unit(300) receives the quantitative water, for generating the steam, supplied by the independent water tank(100), the water for generating the steam is rapidly heated to the boiling point in the rapid evaporation unit(300), the liquid water for generating the steam is transformed into the gaseous cooking steam, the cooking unit(400) is used for containing food needing to be cooked, the check unit(200) is arranged between the independent water tank(100) and the rapid evaporation unit(300), and the check unit(200) has an opened state for discharging water and a closed state for checking.

### FIELD OF THE INVENTION

The invention relates to a rapid food cooking device and a rapid cooking method thereof, especially a rapid food cooking device comprising an independent water tank, a check unit, a rapid evaporation unit and a cooking unit and rapid cooking method thereof. Wherein, the independent water tank is used for containing water for generating steam, the water for generating the steam contained in the independent water tank is constantly and quantitatively supplied to the rapid evaporation unit. The rapid evaporation unit receives the quantitative water for generating the steam supplied by the independent water tank. The water for generating the steam is rapidly heated to the boiling point in the rapid evaporation unit. The liquid water for generating the steam is transformed into the gaseous cooking steam. The cooking unit is used for containing food needing to be cooked. The check unit is arranged between the independent water tank and the rapid evaporation unit, and the check unit has an opened state for discharging water and a closed state for checking.

### THE PRIOR ARTS

As is well known, people usually cook food by frying, stewing and steaming and so on. Wherein steaming is taking steam as heat conductor and heating the material by steam and making the food cooked and crisp with no fire. Cooking food by steaming can keep the original flavor of ingredients at utmost, and lose the original nutrients of ingredients as little as possible. As people pay more attention of health diet, cooking food by steaming is more and more common. After being cooked, the ingredients will be soft and delicious by the heating of steam, especially good for the children and old people. There are some food steaming machines in market for people conveniently cooking food. Foods cooked by these food steaming machines are very soft, if further be smashed, the food will best for children or old people.

When such kind of food steaming machine is in use, there are many disadvantages as follow. Firstly, cooking method of the said seaming machine usually cook the food with high temperature steam flowing through the food by itself. Cooking in this manner, the food maybe being cooked not sufficiently, and the food cooked maybe not soft enough. To avoid this problem, the food usually needs to be cooked for a long time. Such cook manner is in a low efficiency and has no optimal effect.

Secondly, the speed of steam generating of the said food steaming machine in market is very slow because of its structure. Steam can be generated only after all water being heated to boiling point. At the same time, the whole cooking time is usually determined by the volume of water added. The food steaming machine can stop automatically only after all water added being evaporated. If user add water too little due to lacking of experience, the entire cooking process can be finished only after stopping machine and adding water for several times. It is inconvenient for use. The efficiency of steam generating is too low, the time of steam generating is too long, and reduction of power is great, thus is the main disadvantage of traditional technology.

### SUMMARY OF THE INVENTION

The main aim of the present invention is providing a rapid food cooking device and a rapid cooking method thereof. By technical solution of the invention, food can be cooked rapidly, steam can be generated rapidly, and cooking efficiency can be improved greatly.

A rapid food cooking device, comprising an independent water tank, a check unit, a rapid evaporation unit and a cooking unit, wherein the independent water tank is used for containing water for generating steam, the water, for generating the steam, in the independent water tank is constantly and quantitatively supplied to the rapid evaporation unit.

the rapid evaporation unit receives the quantitative water, for generating the steam, supplied by the independent water tank, the water for generating the steam is rapidly heated to the boiling point in the rapid evaporation unit, the liquid water for generating the steam is transformed into the gaseous cooking steam.

the cooking unit is used for containing food needing to be cooked, the cooking steam generated in the rapid evaporation unit instantly enter into the cooking unit to cook the food, the pressure of the cooking unit is lower than atmospheric pressure.

the check unit is arranged between the independent water tank and the rapid evaporation unit, and the check unit has an opened state for discharging water and a closed state for checking, when check unit is in opened sate, the water for generating steam contained in the independent water tank flow into the rapid evaporation unit through the check unit; In closed sate, check unit can prevent the water for generating steam or/and cooking steam from flowing back into the independent water tank.

Pressure of cooking unit is determined by transforming time of check unit from opened state to closed state and transforming time from closed state to opened state.

The amount of water for generating steam provided from the independent water tank to the rapid evaporation unit is determined by transforming time of check unit from opened state to closed state and transforming time from closed state to opened state, therefore the independent water tank can constantly and quantitatively provide water for generating steam to the rapid evaporation unit.

Transforming time of check unit from opened state to closed state and transforming time from closed state to opened state are no more than one second.

In operation, the check unit is firstly in opened state, at this moment, the water for generating steam contained in the independent water tank flow into the rapid evaporation unit through the check unit,after that, the rapid evaporation unit rapidly heats the water for generating the steam to the boiling point, then, the liquid water for generating the steam is transformed into the gaseous cooking steam, and instantly enter into the cooking unit to cook the food, when the pressure of the part of the check unit which is adjacent to the rapid evaporation unit is more than the pressure of the part of the check unit which is adjacent to the independent water tank, pressure of the cooking unit is lower than atmospheric pressure, the check unit is transformed from opened state to closed state, at this time, the cooking unit is in holding pressure state by the check unit, meanwhile, the transforming time of the check unit from opened state to closed state determines the amount of water for generating steam provided from the independent water tank to the rapid evaporation unit,then, in the process of transformation that the water in the rapid evaporation unit rapidly transforming to gaseous cooking steam, the water is rapidly reduced, thus results in the reduction of cooking steam, when the pressure of the part of the check unit which is adjacent to the rapid evaporation unit is less than the pressure of the part of the check unit which is adjacent to the independent water tank, the check unit is transformed from closed state to opened state, at this time, water for generating steam contained in the independent water tank flow into the rapid evaporation unit again through the check unit, reciprocating cycle in this manner.

The time of liquid water for generating the steam being transformed into the gaseous cooking steam is determined by the heating power of the rapid evaporation unit. The pressure of the cooking unit is floated up and down around an rated pressure all along, wherein the rated pressure is more than atmospheric pressure.

The check unit is a suspension check valve and the weight thereof determines the transforming time of check unit from opened state to closed state and transforming time from closed state to opened state.

The check unit and the cooking unit are all arranged in a body, the independent water tank is inserted into the body detachably.

The body comprising a water tank inserting cavity for inserting of the independent water tank, the independent water tank includes a insert-in opening water outlet, when the independent water tank inserts in the water tank inserting cavity, the water tank inserting cavity is communicated with the independent water tank by the insert-in opening water outlet, the water tank inserting cavity is communicated with the rapid evaporation unit by a seal pipe, the top of the check unit is arranged in the water tank inserting cavity, while the bottom is arranged in the seal pipe.

The rapid evaporation unit is connected with the cooking unit by an air passage, the body includes a flip cover in which the air passage is arranged, the cooking unit includes a cooking cup, a cooking basket and a cover, wherein, the cover covers the top of the cooking cup, the cooking basket is arranged in the cooking cup, the cover includes an air inlet which is communicated with the air passage, several air outlet are arranged at the bottom of the cooking basket, an air discharging passage is formed between external surface of the cooking basket and internal surface of the cooking cup. The air inlet, air outlet and the air discharging passage air communicated successively, foods to be cooked are placed in the cooking basket, the cooking steam flow along the air passage, and firstly enter into the cooking basket through the air inlet, then flow through the foods from top to bottom and enter into the air discharging passage through the air outlet, and finally discharged out from the cooking cup.

The air passage is connected with a relief valve arranged at the top of the flip cover. The body further includes a stirring motor, power take-off shaft of the stirring motor is connected with the stirring blade which is arranged at the bottom of the cooking cup and positioned under the cooking basket.

In operation, when the pressure of the rapid evaporation unit is more than the pressure of the independent water tank, the check unit is closed, cooking steam are generated in the rapid evaporation unit and continuously enter into the cooking unit,in the process of transformation that the water entering into the rapid evaporation unit rapidly transforming to gaseous cooking steam, the water is rapidly reduced, thus results in the reduction of cooking steam, with the reduction of the cooking steam, the pressure of the rapid evaporation unit is reduced, when the pressure of the rapid evaporation unit is less than the pressure of the independent water tank, the check unit is opened, the water for generating steam in the independent water tank flow to the rapid evaporation unit through the check unit and transform to cooking steam in the rapid evaporation unit, reciprocating cycle in this manner, transforming time of check unit transforming from opened state to closed state and transforming time from closed state to opened state are determined by the pressure of the rapid evaporation unit and the pressure of the independent water tank,when there is no cooking steam generated in the rapid evaporation unit, the liquid level of the water for generating steam in the rapid evaporation unit is stationary and at the same level with the water in the water tank inserting cavity,if the heating power of the evaporation unit is stationary, the cooking time of the cooking unit is determined by the amount of water for generating steam in the evaporation unit.

A rapid food cooking method, comprising following step:

The first step is pouring the water for generating steam into an independent water tank.

The second step is that the water for generating steam in the independent water tank flow to a rapid evaporation unit through a check unit, at this time, the check unit is in opened state.

The third step is that the rapid evaporation unit rapidly heats the water for generating steam to the boiling point, and the water transform to gaseous cooking steam, then the cooking steam instantly enter into the cooking unit to cook the food contained in the cooking unit.

The fourth step is that when the pressure of the part of the check unit which is adjacent to the rapid evaporation unit is more than the pressure of the part of the check unit which is adjacent to the independent water tank, the check unit is transformed from open state to closed state, at this time, the check unit is transformed from opened state to closed state, at this time, the cooking unit is in holding pressure state by the check unit, meanwhile, the transforming time of the check unit from opened state to closed state determines the amount of water for generating steam provided from the independent water tank to the rapid evaporation unit, thus quantitative supply.

The fifth step is that in the process of part of cooking steam entering into the cooking unit is condensed to condensate water, the pressure of cooking unit is gradually reduced, when the pressure of the part of the check unit which is adjacent to the rapid evaporation unit is less than the pressure of the part of the check unit which is adjacent to the independent water tank, the check unit is transformed from closed state to opened state, at this time, water for generating steam contained in the independent water tank flow into the rapid evaporation unit again through the check unit, reciprocating cycle in this manner.

Pressure of cooking unit is determined by transforming time of check unit from opened state to closed state and transforming time from closed state to opened state, and the pressure of cooking unit is floated up and down around an rated pressure all along, wherein the rated pressure is more than atmospheric pressure. The check unit is a suspension check valve and the weight thereof determines the transforming time of check unit from opened state to closed state and transforming time from closed state to opened state.

The advantages of the invention are as follow. Because the water for generating steam is constantly and quantitatively supplied to the rapid evaporation unit during working, only a little water need to be evaporated during the rapid evaporation unit evaporating the water. In this manner, the rapid evaporation unit must has high evaporation efficiency. That is to say, cooking steam enter into cooking unit within a short time after starting machine, thus shorten the precooking time and accelerate the entire cooking process. In addition, the entire cooking process can be realized by low power rapid evaporation unit, thus energy loss can be reduced greatly. Finally, it is possible to individually arrange the independent water tank relative to other parts by the structure of the check unit, without hot water splashing and stopping work after the independent water tank being detached. When user find that the remained water contained in the independent water tank is not enough, he can detach the water tank individually and pour without hot water splashing and work stopping.

### BRIEF DESCRIPTION OF THE DRAWINGS

FIG. 1 shows the cooking process of the present invention.

FIG. 2 is a sectional view of the present invention.

FIGS. 3 and 4 are perspective views of independent water tank and body of the present invention.

FIGS. 5, 6 and 7 are perspective views of the cooking unit and body of the present invention.

FIG. 8 is the main view of the present invention.

### DETAILED DESCRIPTION OF THE PREFERRED EMBODIMENT

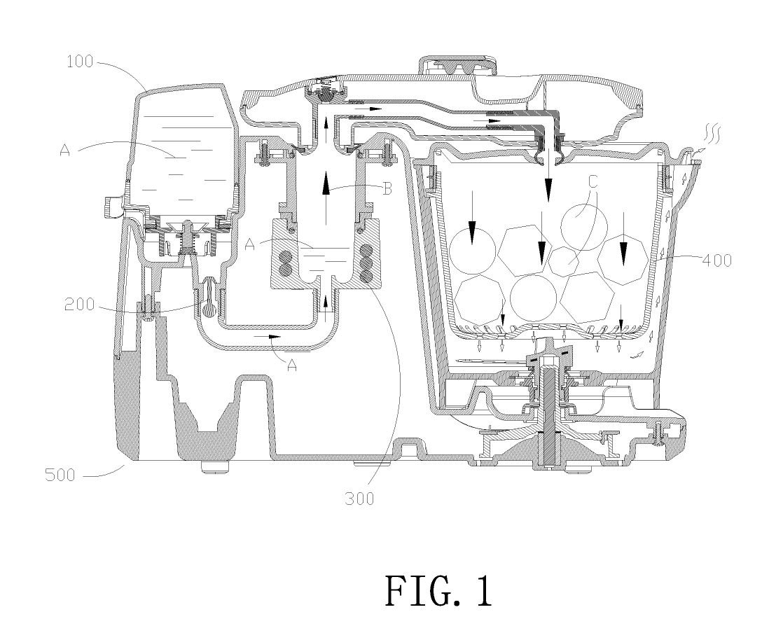

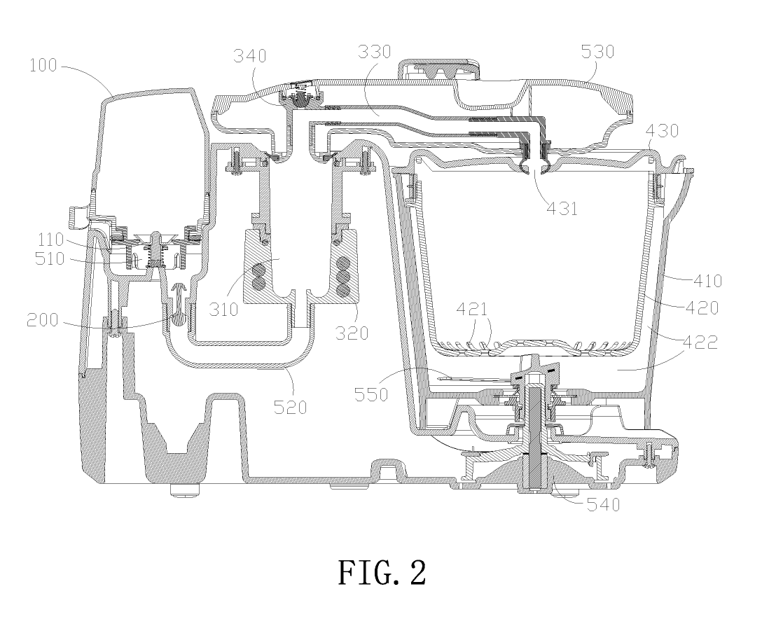

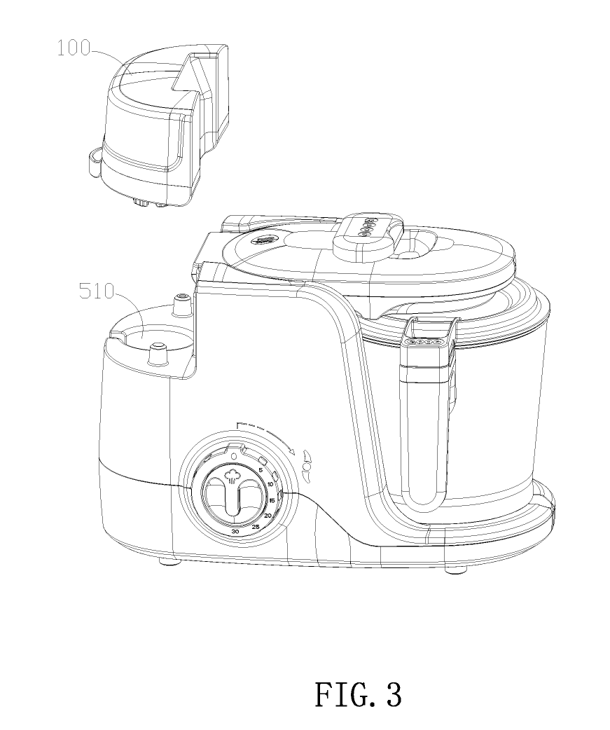

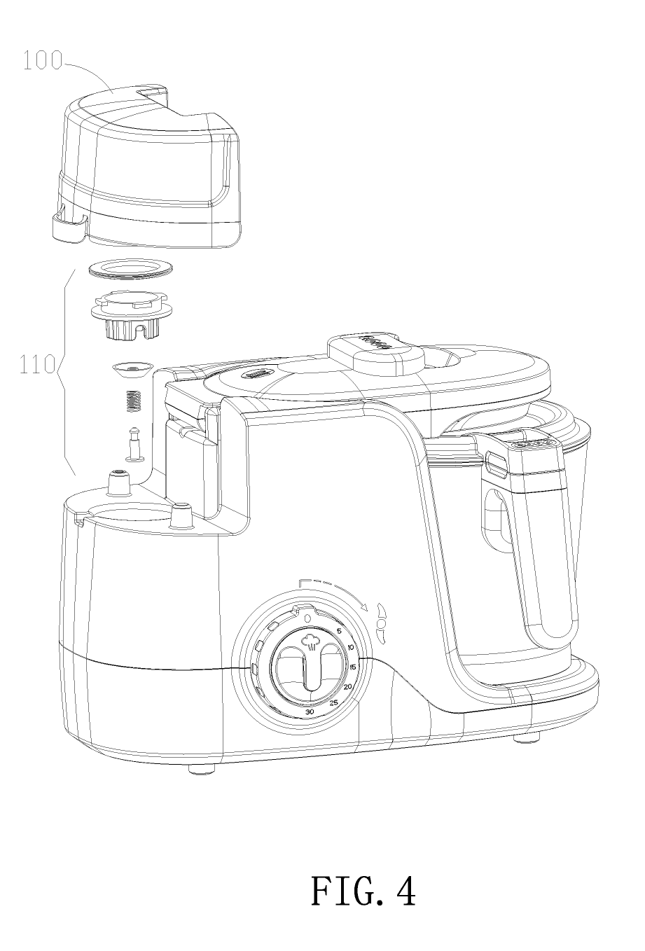

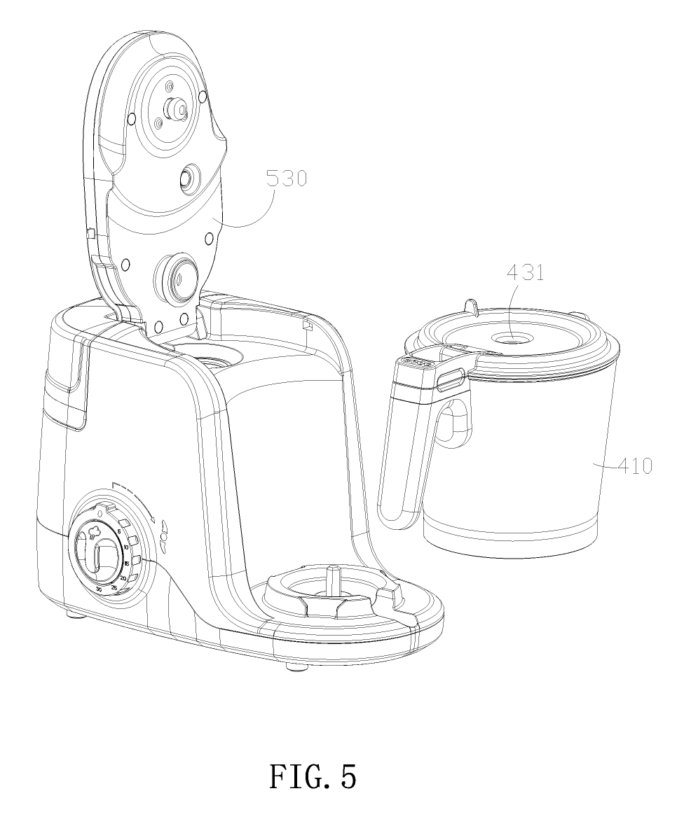

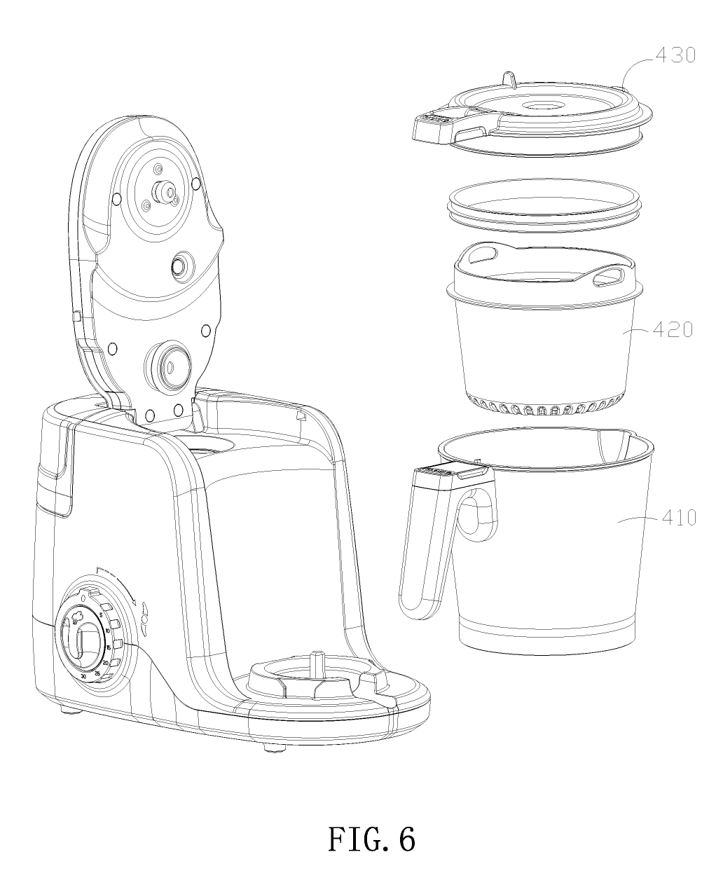

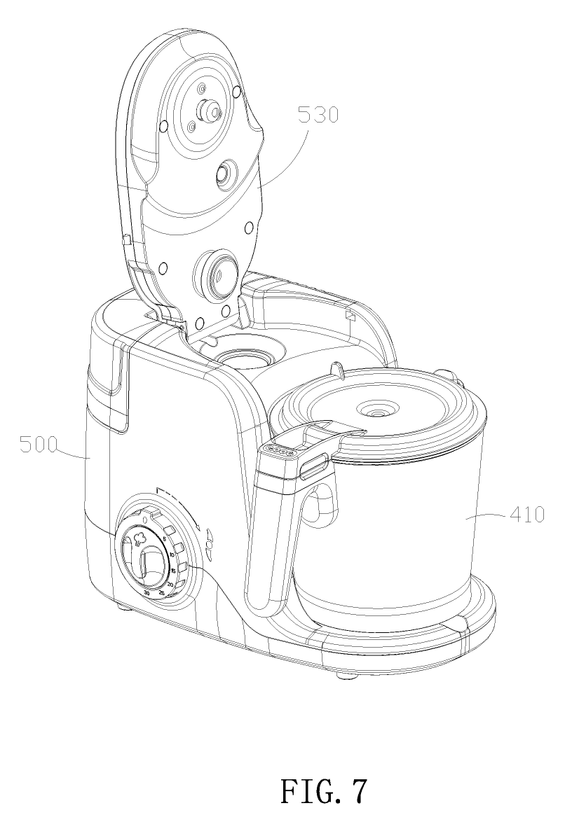

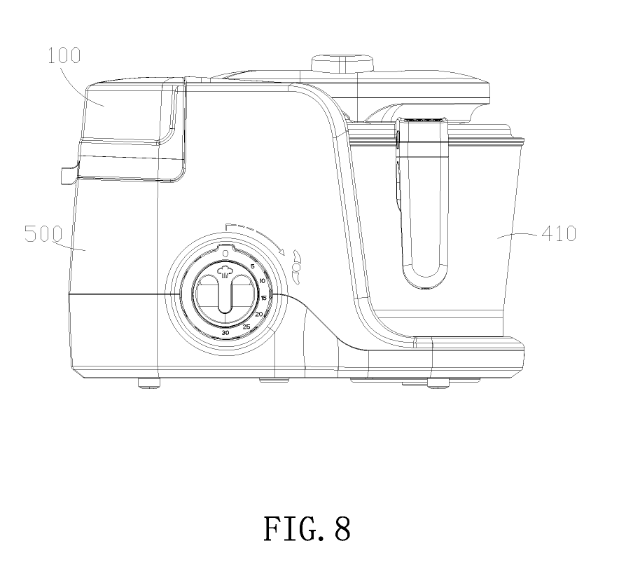

As shown in FIGS. 1 to 8, a rapid food cooking device includes an independent water tank 100, a check unit 200, a rapid evaporation unit 300 and a cooking unit 400, wherein the independent water tank 100 is used for containing water A for generating steam which is constantly and quantitatively supplied to the rapid evaporation unit 300. The independent water tank 100 is convenient for adding water, and the water volume contained in the water tank 100 can be observed by user. At the same time, when in use, the rapid food cooking device can add water repeatedly without stopping the machine by the structure of the independent water tank 100, and does not affect normal cooking.

The rapid evaporation unit 300 receives the quantitative water A for generating the steam supplied by the independent water tank 100. The water A for generating the steam is rapidly heated to the boiling point in the rapid evaporation unit 300, and transformed into the gaseous cooking steam B.

The cooking unit 400 is used for containing food C needing to be cooked, the cooking steam B generated in the rapid evaporation unit 300 instantly enter into the cooking unit 400 to cook the food C.

The pressure of the cooking unit 400 is higher than atmospheric pressure.

The check unit 200 is arranged between the independent water tank 100 and the rapid evaporation unit 300, and the check unit 200 has an opened state for discharging water and a closed state for checking.

When check unit 200 is in opened state, the water A for generating steam contained in the independent water tank 100 flow into the rapid evaporation unit 300 through the check unit 200.

In closed sate, check unit 200 can prevent the water A for generating steam B or/and cooking steam B from flowing back into the independent water tank 100.

At the same time, pressure of cooking unit 400 is determined by transforming time of check unit 200 from opened state to closed state and transforming time from closed state to opened state.

In addition, the amount of water A for generating steam provided from the independent water tank 100 to the rapid evaporation unit 300 is determined by transforming time of check unit 200 from opened state to closed state and transforming time from closed state to opened state, therefore the independent water tank 100 can constantly and quantitatively provide water A for generating steam to the rapid evaporation unit 300.

In specific implementation, transforming time of check unit 200 from opened state to closed state and transforming time from closed state to opened state are no more than one second.

When in work, the check unit 200 is firstly in opened state, at this moment, the water A for generating steam contained in the independent water tank 100 flow into the rapid evaporation unit 300 through the check unit 200.

After that, the rapid evaporation unit 300 rapidly heats the water A for generating the steam to the boiling point, then, the liquid water A is transformed into the gaseous cooking steam B.

Heat power of the evaporation unit 300 determines the transforming time of water A being transformed to cooking steam B.

The cooking steam B enter into the cooking unit 400 instantly to cook the food C.

When the pressure of the part of the check unit 200 which is adjacent to the rapid evaporation unit 300 is more than the pressure of the part of the check unit 200 which is adjacent to the independent water tank 100), the check unit 200 is transformed from opened state to closed state.

At this time, the cooking unit 400 is in holding pressure state by the check unit 200, meanwhile, the transforming time of the check unit 200 being transformed from opened state to closed state determines the amount of water A for generating steam provided from the independent water tank 100 to the rapid evaporation unit 300, thus quantitatively supplement.

After that, in the process of part of cooking steam B entering into the cooking unit 400 is condensed to condensate water D, the pressure of cooking unit 400 is gradually reduced.

When the pressure of the part of the check unit 200 which is adjacent to the rapid evaporation unit 300 is less than the pressure of the part of the check unit 200 which is adjacent to the independent water tank 100, the check unit 200 is transformed from closed state to opened state, at this time, water A contained in the independent water tank 100 flow into the rapid evaporation unit 300 again through the check unit 200, reciprocating cycle in this manner.

During the process said above, the pressure of cooking unit 400 is floated up and down around an rated pressure all along, wherein the rated pressure is more than atmospheric pressure.

Because the water A for generating steam is constantly and quantitatively supplied to the rapid evaporation unit 300 in the process said above, only a little water need to be evaporated during the rapid evaporation unit 300 evaporating the water. In this manner, the rapid evaporation unit 300 must has high evaporation efficiency. That is to say, cooking steam B enter into cooking unit 400 within a short time after starting machine, thus shorten the precooking time and accelerate the entire cooking process.

In addition, the entire cooking process can be realized by low power rapid evaporation unit 300, thus energy loss can be reduced greatly.

Finally, it is possible to individually arrange the independent water tank 100 relative to other parts by the structure of the check unit 200, without hot water splashing and stopping work after the independent water tank 100 being detached.

In specific implement, when the user find that the remained water contained in the independent water tank 100 is not enough, he can detach the water tank 100 individually and pour without hot water splashing and work stopping.

In specific implement, the check unit 200 is a suspension check valve and the weight thereof determines the transforming time of check unit 200 being transformed from opened state to closed state and transforming time from closed state to opened state.

In specific implement, heat power of rapid evaporation unit 300 is about 200 w-450 w.

Material density of the check unit 200 is about 1.0 g/cm³-1.4 g/cm³.

In addition, inventor draws a conclusion by experiment that if the rapid evaporation unit 300 has same heating volume and different heating power, higher power shorter steam generating time, otherwise, lower power longer steam generating time. When the heating power are 200 W and 250 W, actual steam generating time is less than standard steam generating time without affecting use. The experiment data is shown in the table below.

| | project | | |
|---|---|---|---|
| | | Standard steam | Actual steam |
| Heating power of rapid | Heating | generating time S | generating |
| evaporation unit | volume | (second) | time S (second) |
| 450 W | 18.2 cm³ | 56 S +3 S/−5 S | 52 S~57 S |
| 350 W | 18.2 cm³ | 72 S +3 S/−5 S | 70 S~75 S |
| 300 W | 18.2 cm³ | 84 S +3 S/−5 S | 80 S~85 S |
| 250 W | 18.2 cm³ | 101 S +3 S/−7 S | 95 S~102 S |
| 200 W | 18.2 cm³ | 126 S +3 S/−10 S | 118 S~125 S |

| | | |
|---|---|---|
| Suspension check valve | Minimum density 1.0 g/cm³ | GB |
| material density g/cm³ | Maximum density 1.4 g/cm³ | 1003 |

In specific implement, the check unit 200, the rapid evaporation unit 300 and the cooking unit 400 are all arranged in a body 500. The independent water tank 100 is inserted into the body 500 detachably.

The body 500 includes a water tank inserting cavity 510 for inserting of the independent water tank 100, the independent water tank (100) includes a insert-in opening water outlet 110.

When the independent water tank 100 inserts in the water tank inserting cavity 510, the water tank inserting cavity 510 is communicated with the independent water tank 100 by the insert-in opening water outlet 110.

The water tank inserting cavity 510 is communicated with the rapid evaporation unit 300 by a seal pipe 520.

The seal pipe 520 can be made of silica gel, metal or other material.

The top of the check unit 200 is arranged in the water tank inserting cavity 510, while the bottom is arranged in the seal pipe 520.

The rapid evaporation unit 300 includes a heating box 310 and heating pipes 320 coiling round the heating box 310.

The rapid evaporation unit 300 is connected with the cooking unit 400 by an air passage 330.

The body 500 includes a flip cover 530 in which the air passage 330 is arranged.

The air passage 330 is connected with a relief valve 340 which is installed at the top of the flip cover 530.

The cooking unit 400 includes a cooking cup 410, a cooking basket 420 and a cover 430, wherein, the cover 430 covers the top of the cooking cup 410, the cooking basket 420 is arranged in the cooking cup 410.

The cover 430 includes an air inlet 431 which is communicated with the air passage 330.

Several air outlets 421 are arranged at the bottom of the cooking basket 420. An air discharging passage 422 is formed between external surface of the cooking basket 420 and internal surface of the cooking cup 410. The air inlet 431, air outlet 421 and the air discharging passage 422 are communicated successively.

Foods C to be cooked are placed in the cooking basket 420, the cooking steam B flow along the air passage 330, and firstly enter into the cooking basket 420 through the air inlet 431, then flow through the foods from top to bottom and enter into the air discharging passage 422 through the air outlet 421, and finally discharged out from the cooking cup 410.

The body 500 further includes a stirring motor 540, power take-off shaft of the stirring motor 540 is connected with a stirring blade 550 which is arranged at the bottom of the cooking cup 410 and positioned under the cooking basket 420.

As shown in FIGS. 1 to 8, a rapid food cooking method includes following step:

The first step is pouring water A for generating steam into an independent water tank 100.

The second step is that the water A for generating steam in the independent water tank 100 flow to a rapid evaporation unit 300 through a check unit 200, at this time, the check unit 200 is in opened state.

The third step is that the rapid evaporation unit 300 rapidly heats the water A for generating steam to the boiling point, and the water A transform to gaseous cooking steam B, then the cooking steam B instantly enter into the cooking unit 400 to cook the food C contained in the cooking unit 400.

The fourth step is that when the pressure of the part of the check unit 200 which is adjacent to the rapid evaporation unit 300 is more than the pressure of the part of the check unit 200 which is adjacent to the independent water tank 100, the check unit 200 is transformed from opened state to closed state.

At this moment, the cooking unit 400 is in holding pressure state by the check unit 200, at same time, the transforming time of the check unit 200 being transformed from opened state to closed state determines the amount of water A for generating steam provided from the independent water tank 100 to the rapid evaporation unit 300, thus quantitative supply.

The fifth step is that in the process of part of cooking steam B entering into the cooking unit 400 is condensed to condensate water D, the pressure of cooking unit 400 is gradually reduced.

When the pressure of the part of the check unit 200 which is adjacent to the rapid evaporation unit300 is less than the pressure of the part of the check unit 200 which is adjacent to the independent water tank 100, the check unit 200 is transformed from closed state to opened state, at this time, water A for generating steam contained in the independent water tank 100 flow into the rapid evaporation unit 300 again through the check unit 200, reciprocating cycle in this manner.

Pressure of cooking unit 400 is determined by transforming time of check unit 200 being transformed from opened state to closed state and transforming time from closed state to opened state.

In the process said above, the pressure of cooking unit 400 is floated up and down around an rated pressure all along, wherein the rated pressure is more than atmospheric pressure.

The check unit 200 is a suspension check valve and the weight thereof determines the transforming time of check unit 200 being transformed from opened state to closed state and transforming time from closed state to opened state.

What is claimed is:

1. A rapid food cooking device, comprising: an independent water tank, a check unit, a rapid evaporation unit and a cooking unit, wherein the independent water tank is used for containing water for generating steam, the water, for generating the steam, in the independent water tank is constantly and quantitatively supplied to the rapid evaporation unit,
the rapid evaporation unit receives the quantitative water, for generating the steam, supplied by the independent water tank, the water for generating the steam is rapidly heated to the boiling point in the rapid evaporation unit, the liquid water for generating the steam is transformed into the gaseous cooking steam,
the cooking unit is used for containing food needing to be cooked, the cooking steam generated in the rapid evaporation unit instantly enter into the cooking unit to cook the food, the pressure of the cooking unit is lower than atmospheric pressure,
the check unit is arranged between the independent water tank and the rapid evaporation unit, and the check unit has an opened state for discharging water and a closed state for checking, when check unit is in opened sate, the water for generating steam contained in the independent water tank flow into the rapid evaporation unit through the check unit; In closed sate, check unit can prevent the water for generating steam or/and cooking steam from flowing back into the independent water tank.

2. The rapid food cooking device of claim 1, wherein pressure of cooking unit is determined by transforming time of check unit from opened state to closed state and transforming time from closed state to opened state.

3. The rapid food cooking device of claim 1, wherein the amount of water for generating steam provided from the independent water tank to the rapid evaporation unit is determined by transforming time of check unit from opened state to closed state and transforming time from closed state to opened state, therefore the independent water tank can constantly and quantitatively provide water for generating steam to the rapid evaporation unit.

4. The rapid food cooking device of claim 1, wherein transforming time of check unit from opened state to closed state and transforming time from closed state to opened state are no more than one second.

5. The rapid food cooking device of claim 1, wherein in operation, the check unit is firstly in opened state, at this moment, the water for generating steam contained in the independent water tank flow into the rapid evaporation unit through the check unit,
after that, the rapid evaporation unit rapidly heats the water for generating the steam to the boiling point, then, the liquid water for generating the steam is transformed into the gaseous cooking steam, and instantly enter into the cooking unit to cook the food, when the pressure of the part of the check unit which is adjacent to the rapid evaporation unit is more than the pressure of the part of the check unit which is adjacent to the independent water tank, pressure of the cooking unit is lower than atmospheric pressure, the check unit is transformed from opened state to closed state, at this time, the cooking unit is in holding pressure state by the check unit, meanwhile, the transforming time of the check unit from opened state to closed state determines the amount of water for generating steam provided from the independent water tank to the rapid evaporation unit,
then, in the process of transformation that the water in the rapid evaporation unit rapidly transforming to gaseous cooking steam, the water is rapidly reduced, thus results in the reduction of cooking steam,
when the pressure of the part of the check unit which is adjacent to the rapid evaporation unit is less than the pressure of the part of the check unit which is adjacent to the independent water tank, the check unit is transformed from closed state to opened state, at this time, water for generating steam contained in the independent water tank flow into the rapid evaporation unit again through the check unit, reciprocating cycle in this manner.

6. The rapid food cooking device of claim 5, wherein the time of liquid water for generating the steam being transformed into the gaseous cooking steam is determined by the heating power of the rapid evaporation unit.

7. The rapid food cooking device of claim 5, wherein the pressure of the cooking unit is floated up and down around an rated pressure all along, wherein the rated pressure is more than atmospheric pressure.

8. The rapid food cooking device of claim 5, wherein the check unit is a suspension check valve and the weight thereof determines the transforming time of check unit from opened state to closed state and transforming time from closed state to opened state.

9. The rapid food cooking device of claim 5, wherein the check unit and the cooking unit are all arranged in a body, the independent water tank is inserted into the body detachably.

10. The rapid food cooking device of claim 9, wherein the body comprising a water tank inserting cavity for inserting of the independent water tank, the independent water tank includes a insert-in opening water outlet, when the independent water tank inserts in the water tank inserting cavity, the water tank inserting cavity is communicated with the independent water tank by the insert-in opening water outlet, the water tank inserting cavity is communicated with the rapid evaporation unit by a seal pipe, the top of the check unit is arranged in the water tank inserting cavity, while the bottom is arranged in the seal pipe,
the rapid evaporation unit is connected with the cooking unit by an air passage, the body includes a flip cover in which the air passage is arranged, the cooking unit includes a cooking cup, a cooking basket and a cover, wherein, the cover covers the top of the cooking cup, the cooking basket is arranged in the cooking cup, the cover includes an air inlet which is communicated with the air passage, several air outlet are arranged at the bottom of the cooking basket, an air discharging passage is formed between external surface of the cooking basket and internal surface of the cooking cup. The air inlet, air outlet and the air discharging passage air communicated successively, foods to be cooked are placed in the cooking basket, the cooking steam flow along the air passage, and firstly enter into the cooking basket through the air inlet, then flow through the foods from top to bottom and enter into the air discharging passage through the air outlet, and finally discharged out from the cooking cup.

11. The rapid food cooking device of claim 10, wherein the air passage is connected with a relief valve arranged at the top of the flip cover.

12. The rapid food cooking device of claim 10, wherein the body further includes a stirring motor, power take-off shaft of the stirring motor is connected with the stirring blade which is arranged at the bottom of the cooking cup and positioned under the cooking basket.

13. The rapid food cooking device of claim 1, wherein, in operation, when the pressure of the rapid evaporation unit is more than the pressure of the independent water tank, the check unit is closed, cooking steam are generated in the rapid evaporation unit and continuously enter into the cooking unit,
in the process of transformation that the water entering into the rapid evaporation unit rapidly transforming to gaseous cooking steam, the water is rapidly reduced, thus results in the reduction of cooking steam,
with the reduction of the cooking steam, the pressure of the rapid evaporation unit is reduced, when the pressure of the rapid evaporation unit is less than the pressure of the independent water tank, the check unit is opened, the water for generating steam in the independent water tank flow to the rapid evaporation unit through the check unit and transform to cooking steam in the rapid evaporation unit, reciprocating cycle in this manner,
transforming time of check unit transforming from opened state to closed state and transforming time from closed state to opened state are determined by the pressure of the rapid evaporation unit and the pressure of the independent water tank,
when there is no cooking steam generated in the rapid evaporation unit, the liquid level of the water for generating steam in the rapid evaporation unit is stationary and at the same level with the water in the water tank inserting cavity,
if the heating power of the evaporation unit is stationary, the cooking time of the cooking unit is determined by the amount of water for generating steam in the evaporation unit.

14. The rapid food cooking device of claim 8, wherein the heat power of rapid evaporation unit is about 200 w-450 w, the material density of the check unit is about 1.0 g/cm³-1.4 g/cm³.

15. A rapid food cooking method, comprising following step:
the first step is pouring the water for generating steam into an independent water tank;
the second step is that the water for generating steam in the independent water tank flow to a rapid evaporation unit through a check unit, at this time, the check unit is in opened state;
the third step is that the rapid evaporation unit rapidly heats the water for generating steam to the boiling point, and the water transform to gaseous cooking steam, then the cooking steam instantly enter into the cooking unit to cook the food contained in the cooking unit;
the fourth step is that when the pressure of the part of the check unit which is adjacent to the rapid evaporation unit is more than the pressure of the part of the check unit which is adjacent to the independent water tank, the check unit is transformed from open state to closed state, at this time, the check unit is transformed from opened state to closed state, at this time, the cooking unit is in holding pressure state by the check unit, meanwhile, the transforming time of the check unit from opened state to closed state determines the amount of water for generating steam provided from the independent water tank to the rapid evaporation unit, thus quantitative supply,
the fifth step is that in the process of part of cooking steam entering into the cooking unit is condensed to condensate water, the pressure of cooking unit is gradually reduced, when the pressure of the part of the check unit which is adjacent to the rapid evaporation unit is less than the pressure of the part of the check unit which is adjacent to the independent water tank, the check unit is transformed from closed state to opened state, at this time, water for generating steam contained in the independent water tank flow into the rapid evaporation unit again through the check unit, reciprocating cycle in this manner.

16. The rapid food cooking method of claim 15, wherein pressure of cooking unit is determined by transforming time of check unit from opened state to closed state and transforming time from closed state to opened state, and the pressure of cooking unit is floated up and down around an rated pressure all along, wherein the rated pressure is more than atmospheric pressure.

17. The rapid food cooking method of claim 15, wherein the check unit is a suspension check valve and the weight thereof determines the transforming time of check unit from opened state to closed state and transforming time from closed state to opened state.
